(19) United States
(12) Patent Application Publication
(10) Pub. No.: US 2018/0086276 A1
(43) Pub. Date: Mar. 29, 2018

(54) VEHICULAR ROOF RACK WITH NOISE REDUCING CROSSBAR PROFILE

(71) Applicant: MOBIS PARTS AMERICA LLC, Fountain Valley, CA (US)

(72) Inventor: Yukio Isoda, Rancho Palos Verdes, CA (US)

(73) Assignee: MOBIS PARTS AMERICA LLC, Fountain Valley, CA (US)

(21) Appl. No.: 15/280,631

(22) Filed: Sep. 29, 2016

(51) Int. Cl. B60R 9/05; B60R 9/052

(52) U.S. Cl. CPC B60R 9/05; B60R 9/052

(57) ABSTRACT

Disclosed is a vehicular roof rack that is adapted for reducing wind noise. It includes left and right pedestals for attachment to the vehicle and extending above a roof of the vehicle. It further includes an elongated crossbar extending between the left and right pedestals and above the roof of the vehicle, the crossbar having a leading edge, a trailing edge, and a profile along substantially all of its length, the profile including a smoothly curved envelope with no outwardly protruding portions extending outside of the smoothly curved envelope and with at least one step-down groove that is inside of the smoothly curved envelope and located nearer to the leading edge of the crossbar than to the trailing edge. The step-down groove may be on the top, the bottom, or both sides of the crossbar. The pedestals may include step-down grooves that substantially align with the step-down groove of the crossbar.

### BACKGROUND OF THE INVENTION

### Field of the Invention

This patent application relates generally to vehicular roof racks and, more particularly, to a vehicular roof rack having a crossbar with a profile that reduces wind noise.

### Description of Related Art

A common problem with automotive roof racks is wind noise generated by air flowing past the crossbars at high speed while the vehicle 100 is moving at driving speed. The reduction of wind noise for roof crossbars has been a high priority to automakers and quiet operation has been an important requirement of customers.

Automakers have previously used one or a combination of various approaches to try to reduce wind noise, e.g.:

Airfoil-type crossbars—some have experimented with slender airfoil-type crossbars. These cause less noise, but they weaken the crossbar which, of course, is fundamentally needed to supports items above the vehicle.

Asymmetry—Others, as discussed in SAE Paper 2002-01-1275, have looked to asymmetry in section geometry.

Varying Mounting Location—Others have looked into varying the mounting locations of the crossbars, Int. J. Vehicle Noise and Vibration, Vol. 6, Nos. 2/3/4, 2010. In general, however, we do not have the luxury of specifying the locations of the crossbars because styling and utility determines the required locations.

Attack Angle—Some have varied the attack angle, i.e. raising the leading edge of the crossbar relative to the trailing edge. However, this not ideal for carrying items on the crossbars or for mounting other roof accessories. The ideal crossbar is flat or substantially flat on top.

Wind Trips—Some have added wind trips near the leading edge to change the boundary layer from laminar to turbulent to remove the tonal noise. A wind trip is essentially a protruding rib running along the length of the crossbar. A wind trip may be on the top, on the bottom, or both.

FIG. 3 is an isolated perspective view of a prior-art crossbar 120 that features a wind trip (not visible from this perspective, but see cross-sectional profile of FIG. 4).

FIG. 4 is a cross-section of crossbar 120 taken along section lines 4-4, showing an exemplary wind trip 121. Here, the crossbar 120 only has one wind trip 121 on its underside because a topside wind trip may press into and damage items carried by the crossbar 120. In the inventor's experience, the wind trip 121 removes tonal noise that would be present in the absence of the wind trip 121, but seems to generate a new turbulent noise, effectively making the potential cure worse than the original problem.

There remains a need, therefore, for a vehicular roof rack with an improved noise reducing crossbar profile.

### SUMMARY OF THE INVENTION

In a first aspect of the invention, an embodiment resides in a vehicular roof rack that is adapted for reducing wind noise comprising: left and right pedestals for attachment to the vehicle and extending above a roof of the vehicle; and an elongated crossbar extending between the left and right pedestals and above the roof of the vehicle, the elongated crossbar having a leading edge, a trailing edge, and a profile along substantially all of its length, the profile being wider than it is tall to define a top wall with a topside and a bottom wall with an underside and comprising a smoothly curved envelope with no outwardly protruding portions extending outside of the smoothly curved envelope and with at least one step-down groove that is inside of the smoothly curved envelope and located nearer to the leading edge of the crossbar than to the trailing edge.

In various embodiments, the step-down groove can be an upper step-down groove located on a topside of the crossbar, a lower step-down groove located on an underside of the crossbar, or both.

### BRIEF DESCRIPTION OF THE FIGURES

The present invention has other objects and features of advantage which will be more readily apparent from the following description of the best mode of carrying out the invention and the appended claims, when taken in conjunction with the accompanying drawings, in which:

FIG. 1 shows an exemplary vehicle 100 with a roof 101 and a roof rack 10 comprised of a front crossbar 20 and a rear crossbar 20′;

FIG. 2 is a closer-up view of the top of the vehicle 100, focusing on the front crossbar 20 and showing more detail of an exemplary construction;

FIG. 3 is an isolated perspective view of a prior-art crossbar 120 that features a wind trip (not visible from this perspective, but see FIG. 4);

FIG. 4 is a cross-section of prior-art crossbar 120 taken along section lines 4-4 showing an exemplary wind trip 121;

FIG. 5 is an isolated perspective view of a crossbar 20 that has a unique profile with an upper step-down groove 40 and a lower step-down groove 50 according to a first preferred embodiment of the present invention. In the preferred embodiment, the pedestals 30, 30 that receive and support the crossbar 20 further include corresponding step-down grooves 60, 70 that are substantially aligned with the step-down grooves 40, 50 of the crossbar 20;

FIG. 6 is a cross-section of crossbar 20 taken along section lines 6-6 showing the upper step-down groove 40 and the lower step-down groove 50 of the crossbar 20 of FIG. 5 in profile;

FIG. 6A is a cross-section of the crossbar 20 and the pedestal 30 taken along section lines 6A-6A showing the upper step-down grooves 40, 60 and the lower step-down grooves 50, 70 of FIG. 5 in profile;

FIG. 7a is a close-up view of the upper step-down groove 40 from FIG. 6 which has a wall and floor that are substantially flat and which come together in a substantially ninety-degree corner (as might be made by grinding a step-down groove 40 into an existing profile);

FIG. 7b is a close-up view of an alternative embodiment of an upper step-down groove 40′ which has a wall and a floor that are non-flat and which has radiused corners (as might be made in mass production by extruding the step-down groove 40′ into the profile or in a small quantity prototype embodiment by using a specially shaped grinding tool);

FIGS. 8a, 8b, and 8c are similar to FIG. 6, but showing alternative embodiments that feature both upper and lower step-down grooves 40, 50 (FIG. 8a), only a top step-down groove 40 (FIG. 8b), and only a bottom step-down groove 50 (FIG. 8c); and

FIG. 9 is a profile view of a presently preferred version of the crossbar 20 that may be manufactured in mass production quantities using an extrusion process and includes internal support ribs 26, 27 for enhanced strength and rigidity.

### DETAILED DESCRIPTION OF THE PREFERRED EMBODIMENTS

While the present invention will be described with reference to one or more embodiments, the description is merely illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

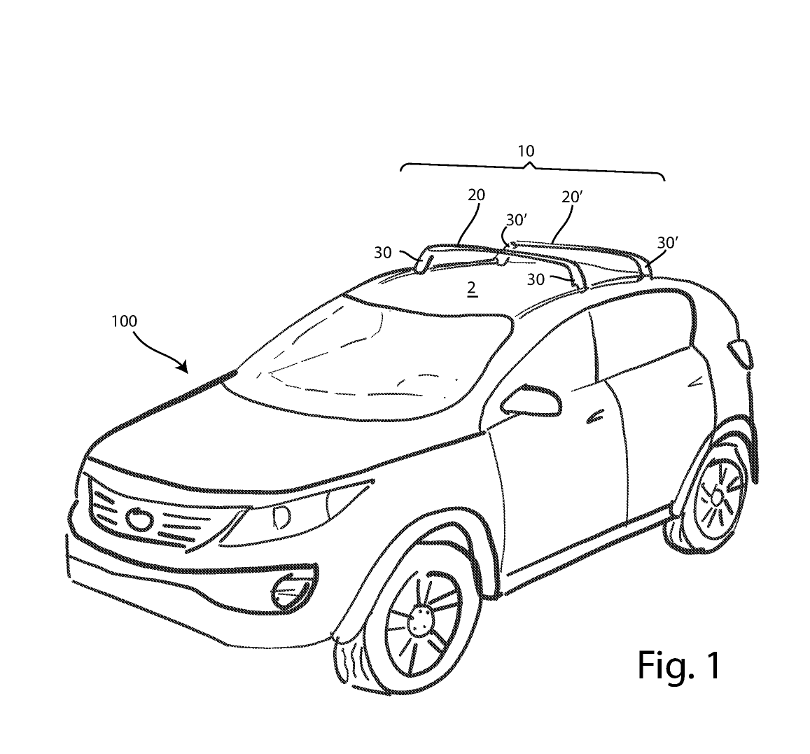

For context, FIG. 1 shows an exemplary vehicle 100 with a roof 101 and a roof rack 10 comprised of a front crossbar 20 and a rear crossbar 20′. Traditionally, the crossbars 20, 20′ are formed from extruded aluminum profiles owing to its amenability to cost effective manufacture, light weight and strength. The roof rack 10 is used to carry luggage, surf boards, skis and the like above the roof 101 of the vehicle 100.

The front crossbar 20 is supported above the vehicle's roof 101 with left and right pedestals 30. The rear crossbar 20′ is similarly is similarly supported by left and right pedestals 30′. In some embodiments the front and rear crossbars 20, 20′ may vary from one another in some physical regard (e.g. the front crossbar may be longer), but for the sake of simplicity, it will be hereafter assumed that the front and rear crossbars 20, 20′ are substantially identical.

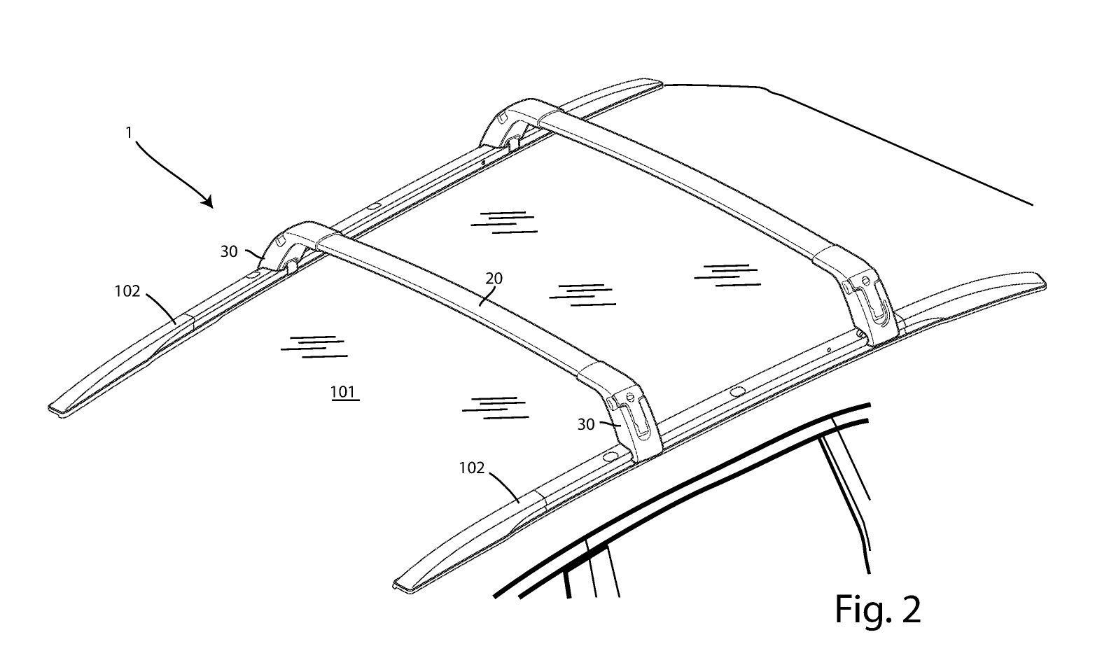

FIG. 2 is a closer-up view of the top of the vehicle 100, focusing on the front crossbar 20 and showing more detail of an exemplary construction of the left and right pedestals 30, 30 and their detachable and/or adjustable attachment to roof rails 102, 102 located on the roof 101 of the vehicle 100. The pedestals 30, 30 may be separable from the crossbar 40, or all three may be provided together as an integral formed unit. The pedestals 30, 30 may be permanently attached to the vehicle 100 or, as shown, repositionable along the roof rails 102, 102 or similar components.

As set forth in the background section above, the prior art attempts to reduce wind noise have involved (1) slender but weaker cross bars, (2) asymmetrical profiles, (3) choosing an ideal rooftop location, (4) increasing the angle of attack, and (5) adding “wind trips” at the leading edge of the crossbar. None of these approaches are ideal and all have drawbacks.

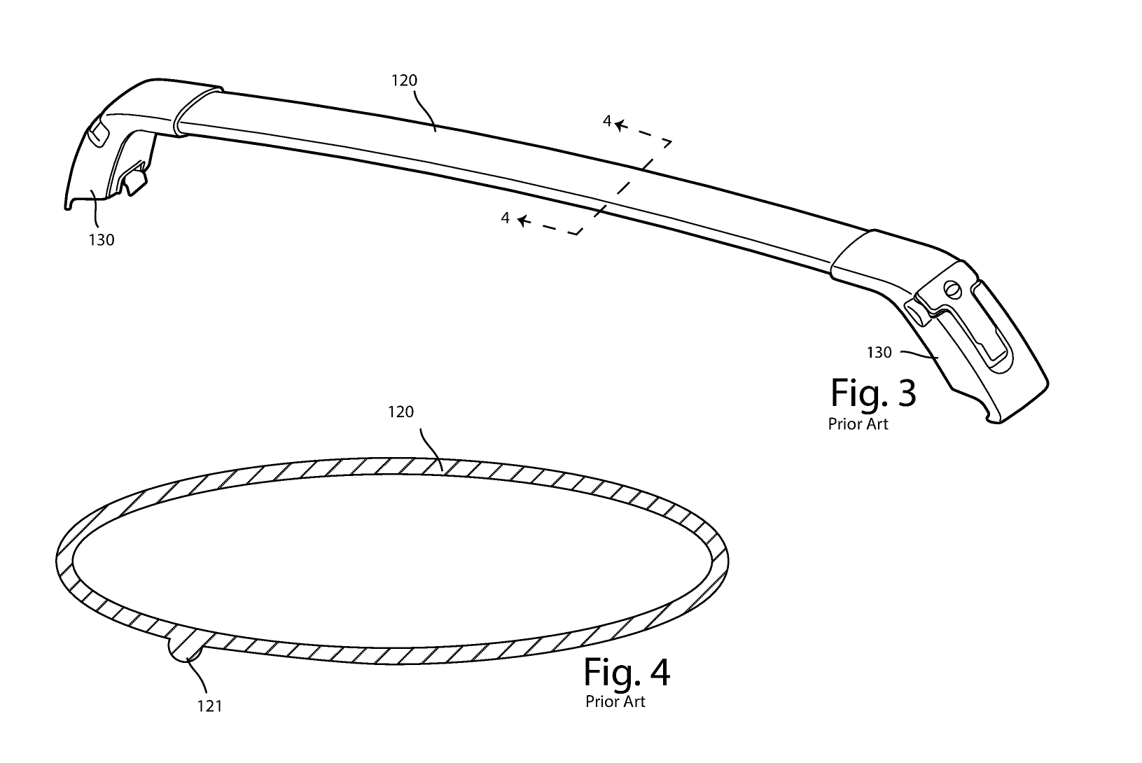

FIGS. 3 and 4, for example, show the prior art approaching of using a protruding wind trip 121 to try to reduce wind noise. As shown, the wind trip 121 extends outwardly beyond the envelope of the crossbar 120. And, as already noted, the primary effect on wind noise seems to be to substitute a different noise for the original noise. While not used here, adding a wind trip to the upper surface is problematic because it may damage items carried on the roof rack or make it difficult to mount accessories (e.g. for special racks or containers mounted between the front and rear crossbars).

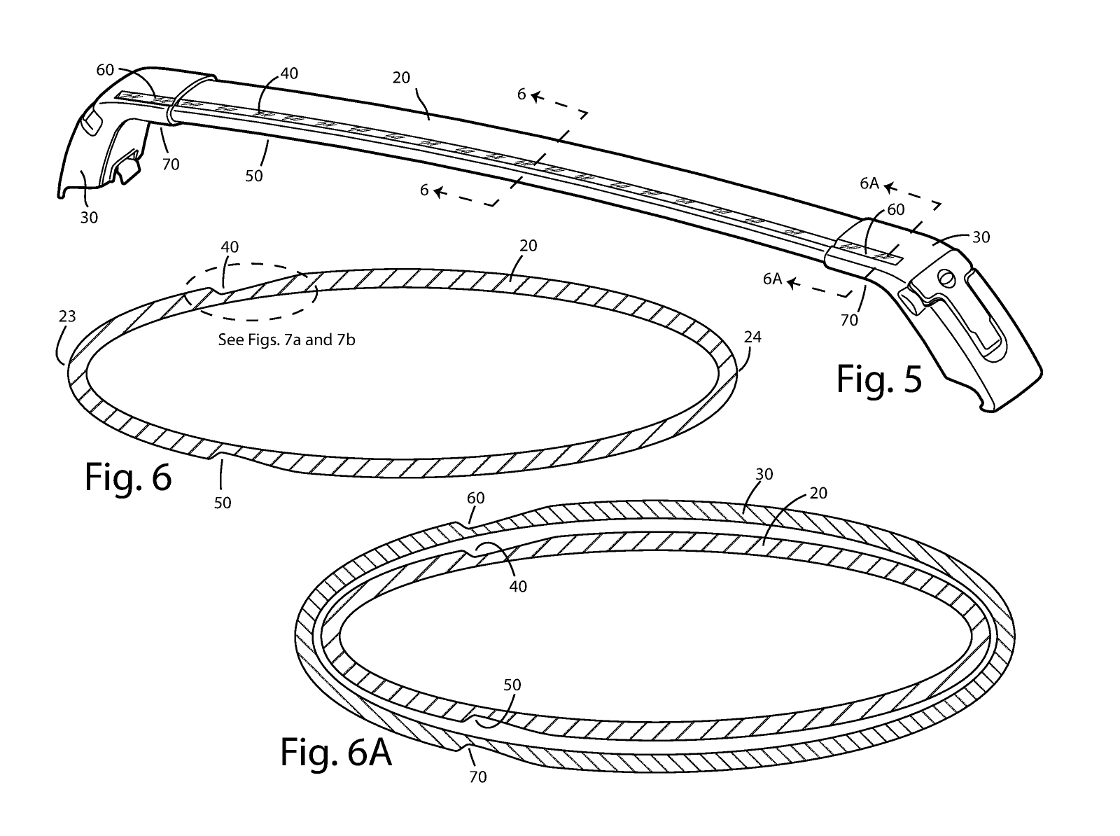

With the reduction of wind noise in mind, FIG. 5 shows a crossbar 20 that has a unique profile according to a first preferred embodiment of the present invention, namely a crossbar 20 with an upper step-down groove 40 and a lower step-down groove 50. Here, the upper step-down groove 40 is seen extending along the entire length of the crossbar 20, from one pedestal 30 to the other. The lower step-down groove 50 is generally identified in FIG. 5, but is not visible in this view, of course, because it is on the underside of the crossbar 20.

The system could use standard pedestals 130 as shown in FIG. 3. In the preferred embodiment, however, the pedestals 30, 30 that receive and support the crossbar 20 also include corresponding step-down grooves 60, 70 that are substantially aligned with the step-down grooves 40, 50 of the crossbar 20. In particular, the pedestals 30, 30 include substantially horizontal extensions that have a profile similar to that of the crossbar 20 in order to slidingly engage with the crossbar 20. The horizontal extension could be smaller in size in order to fit inside of the crossbar 20, but is preferably larger as shown so that the crossbar 20 fits inside of the pedestal 30, 30. The provision of stepdown grooves 60, 70 in at least the horizontal extensions of the pedestal 30 further assists with noise reduction. In order to illustrate this, FIG. 6A is a cross-section of the crossbar 20 and one pedestal 30 taken along section lines 6A-6A showing the upper step-down grooves 40, 60 and the lower step-down grooves 50, 70 of FIG. 5 in profile;

The inventors have confirmed that the preferred embodiment dramatically reduces wind noise. They presently believe that the laminar wind flow promptly spills over the step-down grooves 40 and/or 50 (which has a relatively sharp radius in the prototype), becomes turbulent and, as a result, the wind that is flowing over the top and bottom sides of the crossbar 20 does not noisily re-combined when flowing past the crossbar 20's trailing edge.

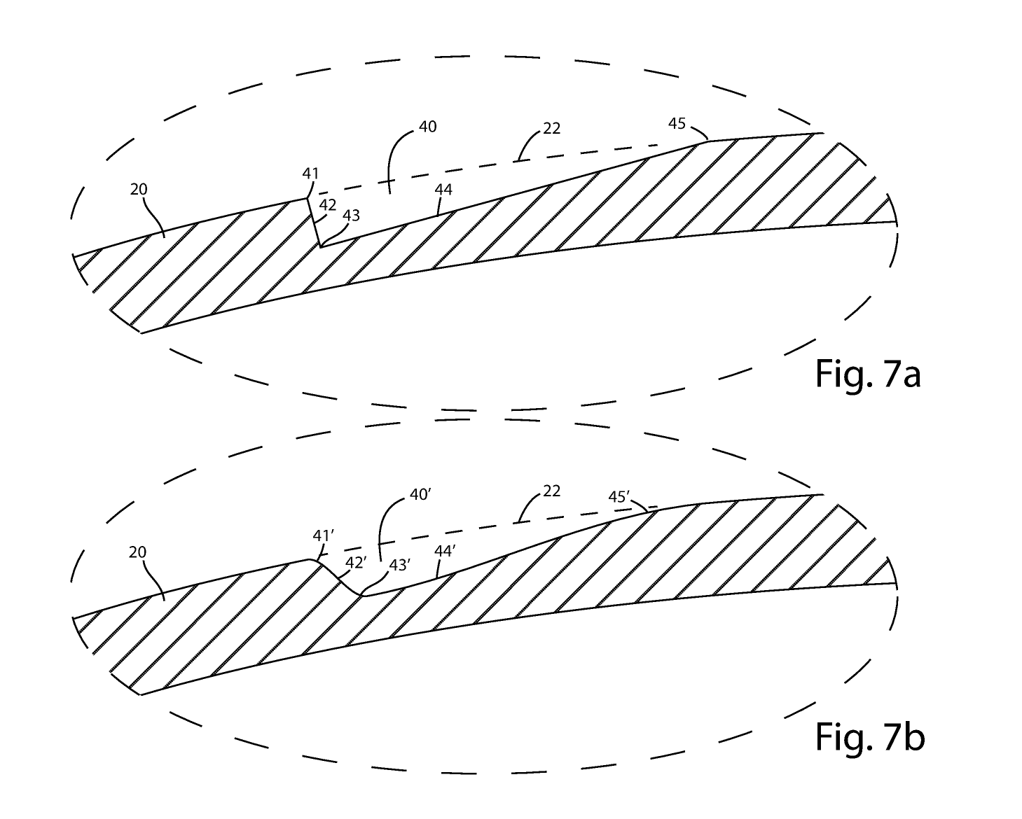

FIG. 6 is a cross-section of the crossbar 20 in FIG. 5, taken along section lines 6-6, showing a presently preferred embodiment of the crossbar 20 with an upper step-down groove 40 and a lower step-down groove 50. As shown, the preferred crossbar 20 has a generally uniform wall thickness which, in the absence of the step-down grooves 40, 50, defines a smoothly curved envelope 22 (see FIGS. 7a and 7b) with no outwardly protruding discontinuities extending outside of the smoothly curved envelope 22. And, as further shown, the crossbar 20 features least one step-down groove 40 or 50 inside of the smoothly curved envelope 22 is located nearer to the leading edge of the crossbar 23 than to the trailing edge 24.

The exact profile of the two step-down grooves 40, 50 may vary without departing from the scope of the present invention and two of many possible embodiments are shown in more detail in FIG. 7a or 7b.

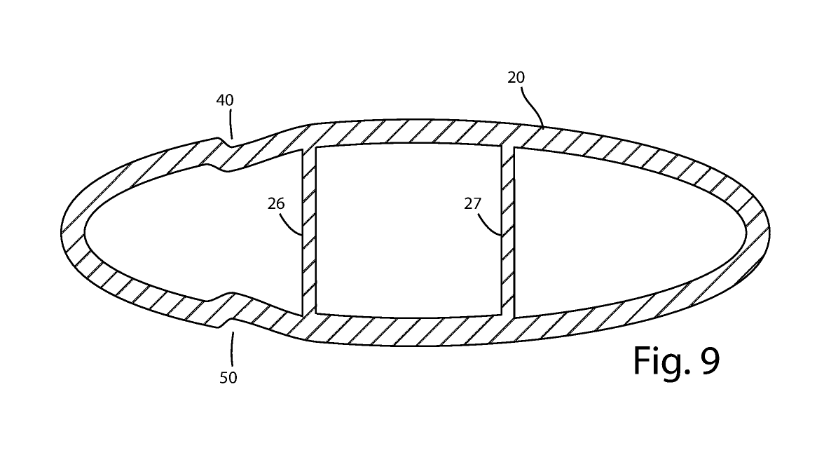

FIG. 7a is a close-up view of the upper step-down groove 40 from FIG. 6 which has a wall 42 and floor 44 that are substantially flat and which come together in a substantially ninety-degree corners 41, 43, 45. This particular embodiment was a prototype created by grinding the step-down groove 40 into an existing profile, basically removing the material from beneath envelope 22. In a mass production embodiment, as shown in FIG. 9 discussed below, the groove 40 would be formed during an extrusion process and without need for grinding. The key here is that the step-down groove 40 modifies the air flow, but does so by removing material from the crossbar 20's envelope 22. Thus, the tonal noises may be modified, but the crossbar 20 doesn't detrimentally include the many drawbacks associated with the prior art, e.g. an upward-facing wind trip, or a heavily angled top surface, etc. If present, the grooves 60, 70 in the pedestals 30, 30 could be similarly configured.

FIG. 7b is a close-up view of an alternative embodiment of the upper step-down from FIG. 6, referred to here by reference number 40′. Here, the alternative step-down groove 40′ features a wall 42′ and a floor 44′ that are non-flat and the step-down groove 40′ has radiused corners 41′ 43′ and 45′. This step-down groove 40 might be creating the step-down groove 40 when extruding the original profile or by using a specially shaped grinding tool. If present, the grooves 60, 70 in the pedestals 30, 30 could be similarly configured.

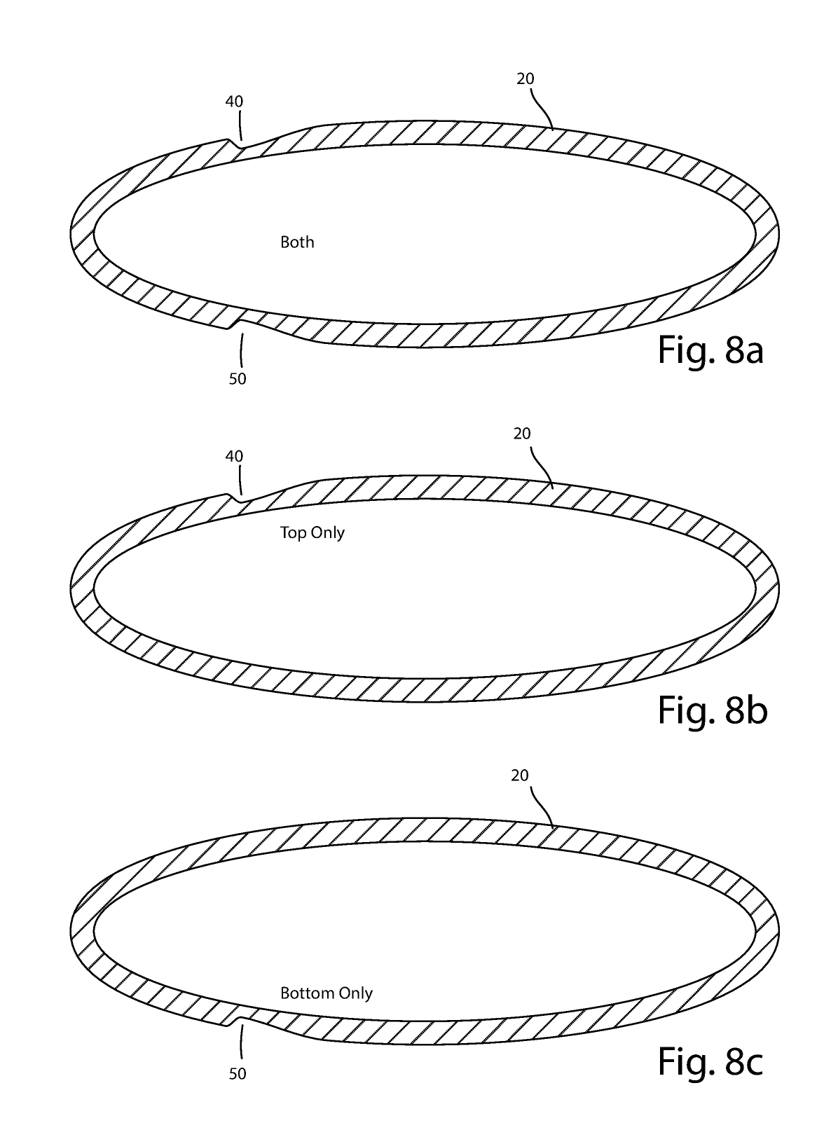

FIGS. 8a, 8b, and 8c are similar to FIG. 6, but showing alternative embodiments that feature both upper and lower step-down grooves 40, 50 (FIG. 8a), only a top step-down groove 40 (FIG. 8b), and only a bottom step-down groove 50 (FIG. 8c). The pedestals 30, 30, of course, could have corresponding grooves 60, 70 on the top and bottom (“both”), the top only, or the bottom only.

The step-down grooves 40 and/or 50 (along with optional grooves 60 and/or 70) beneficially reduce wind noise, but still maintain thickness and strength, do not present protruding geometries (e.g. upward facing wind-trips), and do not involve an excessively angled top surface that makes it difficult to attach accessories.

FIG. 9 shows the profile of a presently preferred version of the crossbar 20 that may be manufactured in mass production quantities using an extrusion process and includes internal support ribs 26, 27 for enhanced strength and rigidity.

Many modifications can be made without departing from the spirit and scope of the claimed invention.

1. A vehicular roof rack that is adapted for reducing wind noise comprising:
left and right pedestals for attachment to the vehicle and extending above a roof of the vehicle;
an elongated, substantially hollow crossbar extending between the left and right pedestals and above the roof of the vehicle, the elongated crossbar having a leading edge, a trailing edge, and a profile along substantially all of its length, the profile being wider than it is tall to define a top wall with a topside and a bottom wall with an underside and comprising a smoothly curved envelope with no outwardly protruding portions extending outside of the smoothly curved envelope and with at least one step-down groove that is inside of the smoothly curved envelope and located nearer to the leading edge of the crossbar than to the trailing edge.

2. The vehicular roof rack of claim 1 wherein the left and right pedestals each include a hollow substantially horizontal extension, the hollow substantially horizontal extensions facing one another and having an extension profile that is configured to slidingly mate with the profile of the elongated crossbar extending therebetween.

3. The vehicular roof rack of claim 1A wherein the hollow substantially horizontal extensions of the left and right pedestals include at a pedestal extension groove that is substantially aligned with the at least one step-down groove of the crossbar.

4. The vehicular roof rack of claim 1 wherein the at least one step-down groove comprises an upper step-down groove located on a topside of the crossbar.

5. The vehicular roof rack of claim 1 wherein the at least one step-down groove comprises a lower step-down groove located on an underside of the crossbar.

6. The vehicular roof rack of claim 1 wherein the at least one step-down groove comprises an upper step-down groove on a topside of the crossbar and a lower step-down groove on an underside of the crossbar.

7. The vehicular roof rack of claim 1 wherein the at least one step-down groove comprises an elongated wall and an elongated floor that are substantially flat and which come together in a substantially ninety-degree corner.

8. The vehicular roof rack of claim 1 wherein the at least one step-down groove comprises an elongated wall and an elongated floor that are substantially non-flat and which come together in a radiused corner.

9. The vehicular roof rack of claim 1 wherein the elongated crossbar is made of metal and wherein the at least one step-down groove is formed therein by removing metal from the elongated crossbar.

10. The vehicular roof rack of claim 1 wherein the elongated crossbar and the at least one step-down groove are extrusion formed.

11. The vehicular roof rack of claim 1 wherein the elongated, substantially hollow crossbar further includes at least one internal rib connecting the top wall with the bottom wall.

12. A vehicular roof rack that is adapted for reducing wind noise comprising:
a first pedestal for attachment to the vehicle and extending above a roof of the vehicle, the first pedestal having hollow substantially horizontal extension extending toward an opposite side of the vehicle;
a second pedestal for attachment to the vehicle and extending above a roof of the vehicle, the second pedestal having hollow substantially horizontal extension extending toward an opposite side of the vehicle;
an elongated, substantially hollow crossbar received by and extending between the hollow substantially horizontal extensions of the first and second pedestals, the elongated crossbar having a leading edge, a trailing edge, and a crossbar profile along substantially all of its length, the profile being wider than it is tall to define a top wall with a topside and a bottom wall with an underside and comprising a smoothly curved envelope with no outwardly protruding portions extending outside of the smoothly curved envelope;
the elongated crossbar including at least one elongated step-down groove that is inside of the smoothly curved envelope and located nearer to the leading edge of the crossbar than to the trailing edge; and
the hollow substantially horizontal extensions of the first and second pedestals each including at least one step-down groove that is substantially aligned with the elongated step-down groove.

13. The vehicular roof rack of claim 12 wherein the at least one step-down groove comprises an upper step-down groove located on a topside of the crossbar.

14. The vehicular roof rack of claim 12 wherein the at least one step-down groove comprises a lower step-down groove located on an underside of the crossbar.

15. The vehicular roof rack of claim 12 wherein the at least one step-down groove comprises an upper step-down groove on a topside of the crossbar and a lower step-down groove on an underside of the crossbar.
